(19) United States
(12) Patent Application Publication
(10) Pub. No.: US 2009/0045751 A1
(43) Pub. Date: Feb. 19, 2009

(54) SYSTEMS FOR DISPLAYING IMAGES

(75) Inventor: Du-Zen PENG, Jhubei City (TW)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/190,761

(22) Filed: Aug. 13, 2008

(30) Foreign Application Priority Data
Aug. 15, 2007 (TW) 096130139

(51) Int. Cl. G09G 3/10

(52) U.S. Cl. 315/169.2

(57) ABSTRACT

A pixel unit is provided. A storage capacitor is coupled to a power supply. A first transistor is coupled to the storage capacitor and receives a data line signal and a scan line signal, and is turned on according to the scan line signal to transmit the data line signal. A second transistor is coupled to the power supply, the first transistor and the storage capacitor, and receives the data line signal from the first transistor. A first switch unit is turned on according to a control signal to output a first current at a first emission period. A second switch unit is turned on according to the control signal to output a second current at a second emission period. A first display unit receives the first current to emit light and a second display unit receives the second current to emit light.

### CROSS REFERENCE TO RELATED APPLICATIONS

This Application claims priority of Taiwan Patent Application No. 096130139, filed on Aug. 15, 2007, the entirety of which is incorporated by reference herein.

### BACKGROUND OF THE INVENTION

1. Field of the Invention

The invention relates to a pixel unit and, in particular, to a pixel unit capable of emitting light toward two opposite directions.

2. Description of the Related Art

Organic light emitting diode (OLED) displays that use organic compounds as a light emission material for emitting light are flat displays. Advantages of OLED display include smaller size, lighter weight, wider viewing angle, higher contrast ratio and higher speed.

Active matrix organic light emitting diode (AMOLED) displays are currently emerging as the next generation flat panel display. Compared with an active matrix liquid crystal display (AMLCD), the AMOLED display has many advantages, such as higher contrast ratio, wider viewing angle, thinner module without backlight, lower power consumption, and lower cost. Unlike the AMLCD, which is driven by a voltage source, an AMOLED display requires a current source to drive an electroluminescent (EL) device. The brightness of the EL device is proportional to the current conducted thereby. Variations of the current level of the current through the EL device have a great impact on brightness uniformity of AMOLED displays. Recently, electronic products, such as mobile phones, comprising two displays have become more and more popular. Thus, emitting light towards two sides of a display has become an important issue for electronic product development.

### BRIEF SUMMARY OF THE INVENTION

A detailed description is given in the following embodiments with reference to the accompanying drawings.

An embodiment of a pixel unit is provided. The pixel unit comprises a storage capacitor, a first transistor, a second transistor, a first switch unit, a second switch unit, a first display unit and a second display unit. The storage capacitor is coupled to a power supply. The first transistor is coupled to the storage capacitor and receives a data line signal and a scan line signal, and is turned on according to the scan line signal to transmit the data line signal. The second transistor is coupled to the power supply, the first transistor and the storage capacitor, and receives the data line signal from the first transistor. The first switch unit is turned on according to a control signal to output a first current at a first emission period. The second switch unit is turned on according to the control signal to output a second current at a second emission period. The first display unit receives the first current to emit light and the second display unit receives the second current to emit light.

### BRIEF DESCRIPTION OF THE DRAWINGS

The invention can be more fully understood by reading the subsequent detailed description and examples with references made to the accompanying drawings, wherein:

FIG. 1 shows a pixel unit according to an embodiment of the invention;

FIG. 2 shows a circuit layout diagram based on the pixel unit of FIG. 1;

FIG. 3 shows a cross-section diagram of an example of the pixel unit of FIG. 2;

FIG. 4 shows a cross section diagram of another example of the pixel unit of FIG. 2; and

FIG. 5 schematically shows another embodiment of an image display system.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

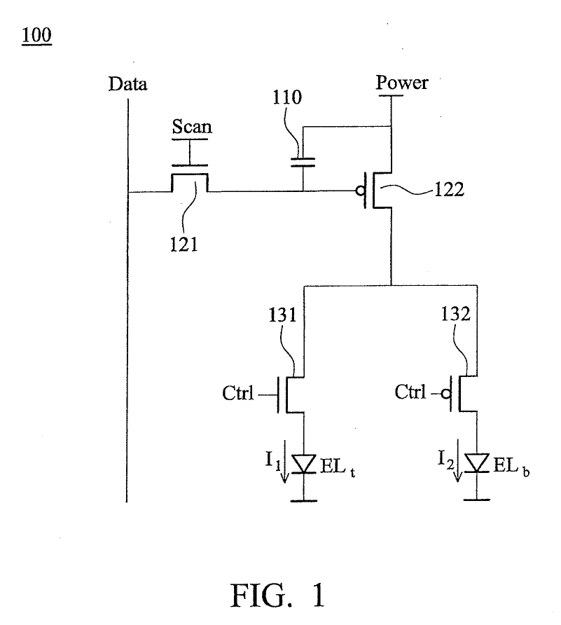

FIG. 1 shows a pixel unit 100 according to an embodiment of the invention. The pixel unit 100 comprises a storage capacitor 110, transistors 121 and 122, switch units 131 and 132 and display units ELₜ and EL_{b}. The storage capacitor 110 is coupled to a power supply and the transistors 121 and 122. The transistor 121 is turned on according to the scan line signal Scan to transmit a data line signal Data to the gate of the transistor 122 and stores the data line signal Data into the storage capacitor 110. The transistor 122 is coupled to the power supply, the transistor 121 and the storage capacitor 110. The switch unit 131 is turned on according to the control signal Ctrl during the first emission period to output a current I1 to the display unit ELₜ for emitting light. The switch unit 132 is turned on according to the control signal Ctrl during the second emission period to output a current I2 to the display unit EL_{b} for emitting light.

According to an embodiment of the invention, the switch unit 131 is an n-type metal-oxide-semiconductor (NMOS) and the switch unit 132 is a p-type metal-oxide-semiconductor (PMOS). The control signal Ctrl is at a high voltage level during the first emission period and at a low voltage level during the second emission period. Thus, the display units ELₜ and EL_{b} do not emit light at the same time. The display units ELₜ and EL_{b} respectively emit light during the first emission period and the second emission period of one frame.

According to another embodiment of the invention, the switch unit 131 is a PMOS (not shown in FIG. 1) and the switch unit 132 is a NMOS (not shown in FIG. 1). The control signal Ctrl is at a low voltage level during the first emission period and at a high voltage level during the second emission period. Thus, the display units ELₜ and EL_{b} do not emit light at the same time. The display units ELₜ and EL_{b} respectively emit light during the first emission period and the second emission period of one frame.

The lights respectively emitted from the display units ELₜ and EL_{b} are approximately in opposite directions. For example, the display unit ELₜ emits light towards an upward direction of the pixel unit of a panel and the display unit EL_{b} emits light towards a downward direction of the pixel unit of a panel.

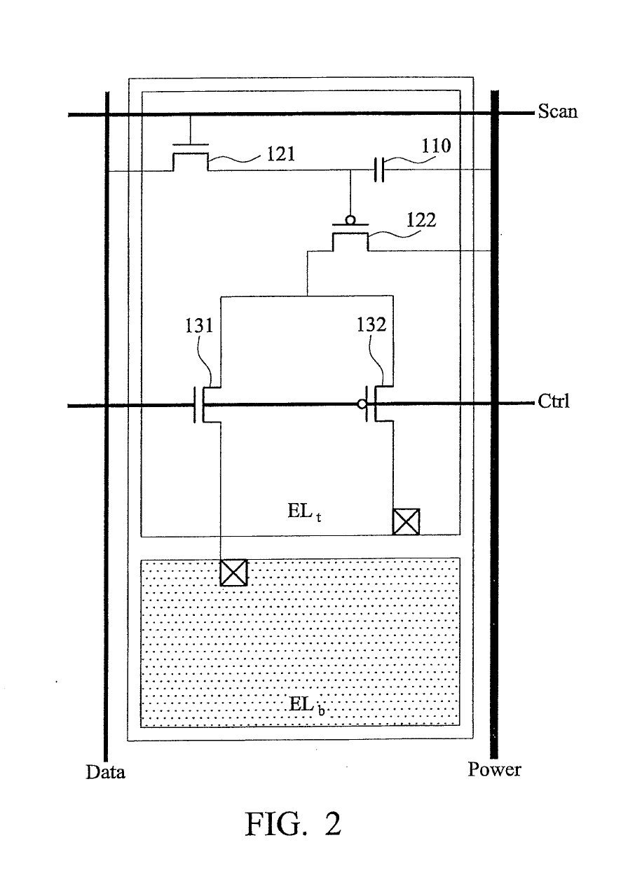

FIG. 2 shows a circuit layout diagram based on the pixel unit 100 of FIG. 1. As shown in FIG. 2, the storage capacitor 110, the transistors 121 and 122, the switch units 131 and 132 are disposed on the backside of the display unit ELₜ, not blocking the display unit ELₜ emitting light toward an upward direction. Thus, the display unit ELₜ can have a larger emitting area toward an upward direction. There are no storage capacitor 110, transistors 121 and 122, switch units 131 and 132 on the emitting area of the display unit EL_{b}. In addition, the display units EL_{b} and ELₜ share the transistors 121 and 122 and the storage capacitor 110 to reduce the circuit layout size of the pixel unit so that the display panel can have more pixel units.

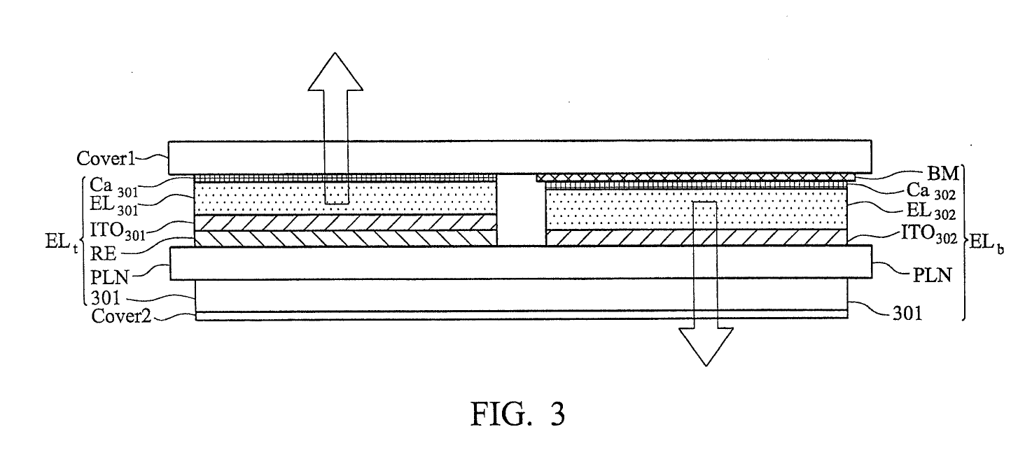

FIG. 3 shows a cross-section diagram of an example of the pixel unit 100 of FIG. 2. The display unit ELₜ comprises a cathode Ca₃₀₁, an emission layer EL₃₀₁, an anode ITO₃₀₁, a reflective electrode RE, a planer layer PLN and an array substrate 301. The cathode Ca₃₀₁ can be a translucent or transparent conducting layer, such as ITO, IZO, ZnO, thin Al—Ag alloy, thin aluminum layer, thin silver layer and so on . . . . The emission layer EL₃₀₁ that receives the current I₁ to emit light is disposed between the cathode Ca₃₀₁ and the anode ITO₃₀₁. The reflective electrode RE is disposed under the anode ITO₃₀₁. The reflective electrode RE can be an opaque metal layer to reflect the downward emitted light from the upper emission layer EL₃₀₁ so that the emitted light from the display unit Elₜ almost emits toward the upward direction, as shown the arrow in FIG. 3. In an embodiment of the invention, the material of the reflective electrode RE can be molybdenum (Mo) or aluminum (Al). The display unit ELₜ is disposed between glass protection layers Cover1 and Cover2. The display unit ELₜ emits light toward an upward direction and the reflective layer RE can reflect the light from the upper emission layer EL₃₀₁. Similar to the display unit ELₜ, the display unit EL_{b} comprises a black matrix BM, a cathode Ca₃₀₂, an emission layer EL₃₀₂, an anode ITO₃₀₂, a planer layer PLN and an array substrate 301. Note that the same layers in the display units ELₜ and EL_{b} use the same materials and processes for fabrication. For example, the cathode Ca₃₀₁ and the cathode Ca₃₀₂ are manufactured by the same processes and the same materials. The emission layer EL₃₀₁ and the emission layer EL₃₀₂ also use the same processes and materials for fabrication and so forth. The black matrix BM is disposed above the emission layer EL₃₀₂ and absorbs or reflects the upward emitted light from the emission layer EL₃₀₂ so that the display unit EL_{b} can emit most light toward a downward direction. The emission layer EL₃₀₂ is disposed between the anode ITO₃₀₂ and the cathode Ca₃₀₂. The display unit EL_{b} is also disposed between the glass protection layers Cover1 and Cover2. In addition, the anodes ITO₃₀₁ and ITO₃₀₂ are transparent layers. The anode can be made from Indium Tin Oxide.

In addition, as shown in FIG. 2, the storage capacitor 110, the transistors 121 and 122, the switch units 131 and 132 are disposed inside the array substrate 131 of the back side of the display unit ELₜ and do not block the upward emitted light from the display unit ELₜ. Thus, the display unit ELₜ emits the upward light more efficiently. The front side of the display unit EL_{b} comprises a black matrix BM, and only the contact holes of the array substrate 301 in the back side of the display unit EL_{b} may partially block the downward emitted light from the emission layer EL₃₀₂ (as shown in FIG. 2). Thus, the display unit EL_{b} emits light toward the downward direction more efficiently. The glass protection layer Cover2 is disposed under the array substrate 301, as shown in FIG. 3. According to an embodiment of the invention, the emission layers EL₃₀, and EL₃₀₂ can emit the same colored lights, such as red light, green light or blue light, for the display panel to utilize. Different pixel units can emit different colored lights. For example, the pixel unit 100 of FIG. 1 emits red light and another pixel unit (not shown) emits blue light.

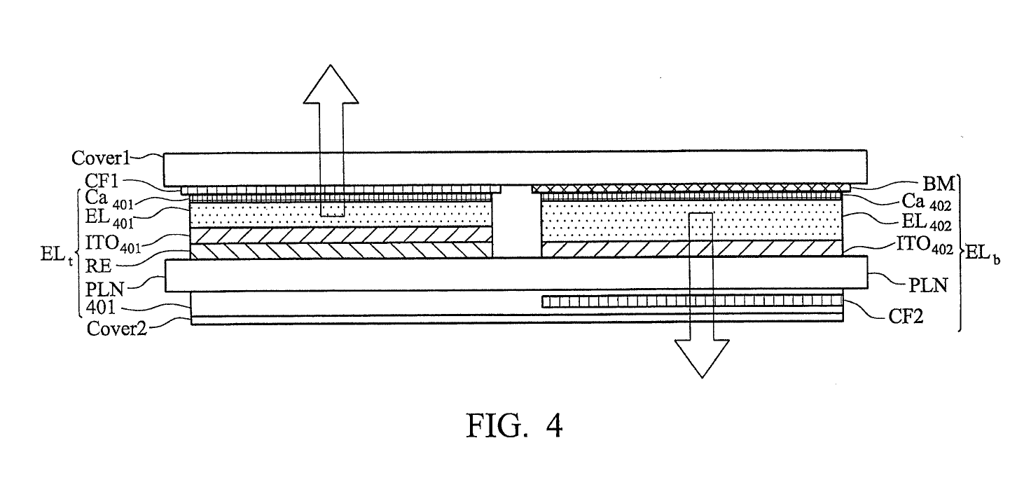

FIG. 4 shows a cross section diagram of another example of the pixel unit 100 of FIG. 2. The display unit ELₜ includes a color filter CF1, a cathode Ca₄₀₁, an emission layer EL₄₀₁, an anode ITO₄₀₁, a reflective electrode RE, a planer layer PLN and an array substrate 301. The cathode Ca₄₀₁ can be a translucent or transparent conducting layer, such as ITO, IZO, ZnO, thin Al—Ag alloy, thin aluminum layer, thin silver layer and so on . . . . The emission layer EL₄₀₁ is disposed between the cathode Ca₄₀₁ and the anode ITO₄₀₁ for receiving the current I₁ to emit light. Similar to FIG. 3, wherein the reflective electrode RE is disposed under the anode ITO₄₀₁. The reflective electrode RE may be an opaque metal layer, which is molybdenum (Mo) or aluminum (Al) for reflecting the downward emitted light from the upper emission layer EL₄₀₁. Therefore, the display unit ELₜ can emit most light toward an upward direction, as shown the arrow in FIG. 4. The display unit ELₜ is disposed between the glass protection layers Cover1 and Cover2. The display unit ELₜ emits light toward an upward direction and the reflective electrode RE can reflect the light from the emission layer EL₄₀₁. The display unit EL_{b} comprises a black matrix BM, a cathode Ca₄₀₂, an emission layer EL₄₀₂, an anode ITO₄₀₂, a planer layer PLN and an array substrate 401 (note that a color filter CF2 is disposed inside of the array substrate 401). Wherein the emission layer EL₄₀₂ is disposed under the cathode Ca₄₀₂ and receives the current I₂ to emit light. The anode ITO₄₀₂ is disposed under the emission layer EL₄₀₂. The display unit EL_{b} is also disposed between the glass protection layers Cover1 and Cover2. According to an embodiment of the invention, the storage capacitor 110, the transistors 121 and 122, and the switch units 131 and 132 are disposed inside the array substrate 401 of the back of the display unit ELₜ and do not block the upward emitted light from the display unit ELₜ. Thus, the display unit ELₜ emits light toward the upward direction more efficiently. The front side of the display unit EL_{b} comprises a black matrix BM, and only the contact holes of the array substrate 301 in the back side of the display unit EL_{b} may partially block the downward emitted light from the emission layer EL₃₀₂ (as shown in FIG. 2). In addition, the back side of the display unit EL_{b} comprises a color filter CF2. Thus, the display unit EL_{b} emits light toward the downward direction more efficiently. The glass protection layer Cover2 is disposed under the array substrate 401, as shown in FIG. 4. The anodes ITO₄₀₁ and ITO₄₀₂ are transparent layers. According to another embodiment of the invention, the emission layers EL₄₀₁ and EL₄₀₂ can emit a single colored light, such as a white light. The single colored light is filtered by the color filter CF2 to generate different colored lights, such as red light, green light or blue light, for panel display.

As shown in FIG. 4, the storage capacitor 110, transistors 121 and 122 and switch units 131 and 132 are disposed at a back-region under the display unit ELₜ to avoid blocking the light penetration path of the display unit EL_{b}. Only the color filter CF2 is disposed on the light penetration path of the display unit EL_{b}.

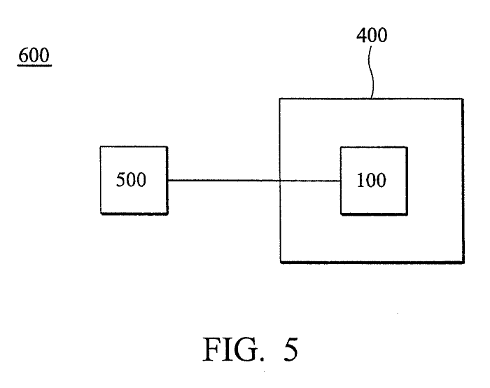

FIG. 5 schematically shows another embodiment of a system for displaying images. In this case, the image display system is implemented as a display panel 400 or an electronic device 600. As shown in FIG. 5, the display panel 400 comprises a plurality of pixel units 100 of FIG. 1. The display panel 400 can form a portion of a variety of electronic devices (in this case, the electronic device 600). Generally, the electronic device 600 can comprise a display panel 400 and a power supply 500. Further, the power supply 500 is operatively coupled to the display panel 400 and provides power to the display panel 400. The electronic device 600 can be a mobile phone, a digital camera, a PDA (personal data assistant), a notebook computer, a desktop computer, a television, or a portable DVD player, for example.

All in all, the display units ELₜ and EL_{b} of the pixel unit 100 of the invention can respectively emit light toward upward and downward directions during a period of one frame. Each switch unit 131 and 132 can respectively control the display unit ELₜ and EL_{b} to emit light. Thus, the pixel unit 100 can independently display two different images on two sides (top side and bottom side). The pixel unit 100 comprises two sub-pixels. Each sub-pixel unit comprises a switch unit and a display unit. In addition, the thin film transistors are disposed under the display unit ELₜ and not disposed under the display unit EL_{b}. Thus, the display unit ELₜ can emit light approximately toward an upward direction and the display unit EL_{b} can emit light approximately toward a downward direction. The pixel unit 100 can also be formed by the conventional processes without increasing manufacturing complexity.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for displaying images, comprising:
a pixel unit, comprising:
a first switch unit, which is turned on during a first emission period according to a control signal to output a first current;
a second switch unit, which is turned on during a second emission period according to the control signal to output a second current;
a first display unit, which receiving the first current to emit light; and
a second display unit, which receiving the second current to emit light,
wherein the first emission and the second emission periods do not overlap.

2. The system as claimed in claim 1, further comprising:
a first transistor receiving a data line signal and a scan line signal and transmitting the data line signal when the first transistor is turned on according to the scan line signal;
a storage capacitor coupled to the first transistor to store the data line signal; and
a second transistor coupled to a power supply, the first transistor, the first switch unit, the second switch unit and the storage capacitor, and receiving the data line signal from the first transistor.

3. The system as claimed in claim 2, wherein the first display unit and the second display unit share the first transistor, the second transistor and the storage capacitor.

4. The system as claimed in claim 1, wherein the first display unit comprises a reflective layer to reflect light from the first display unit so as to approximately emit light in a first direction.

5. The system as claimed in claim 1, wherein the second display unit comprises a black matrix so as to approximately emit light in a second direction.

6. The system as claimed in claim 1, wherein the first display unit comprises:
a first emission layer receiving the first current to emit light;
an array substrate, wherein the first and second switch units are disposed on the array substrate; and
a reflective layer disposed between the first emission layer and the array substrate.

7. The system as claimed in claim 6, wherein the second display unit comprises:
a second emission layer receiving the second current to emit light;
an array substrate, wherein the first and second switch units are disposed on the array substrate; and
a black matrix, which reflecting or absorbing the emitted light from the second emission layer, disposed on the second emission layer and the array substrate.

8. The system as claimed in claim 7, wherein the first and second emission layers are disposed above a first planer layer.

9. The system as claimed in claim 7, wherein the first and the second emission layers comprise an anode respectively and the anode is a transparent layer.

10. The system as claimed in claim 1, wherein the first display unit comprises:
a first color filter filtering light from the first display unit;
a first emission layer disposed under the first color filter and receiving the first current to emit light;
an array substrate, wherein the first and second switch units are disposed on the array substrate; and
a reflective layer disposed between the first emission layer and the array substrate.

11. The system as claimed in claim 10, wherein the second display unit comprises:
a second emission layer receiving the second current to emit light;
an array substrate, wherein the first and second switch units are disposed on the array substrate;
a second color filter filtering the light from the second display unit; and
a black matrix, which reflecting or absorbing the emitted light from the second emission layer, disposed on the second emission layer and the array substrate.

12. The system as claimed in claim 11, wherein the reflective layer and the first and the second emission layers are disposed above a first planer layer, and the first planer layer is disposed above the second color filter.

13. The system as claimed in claim 11, wherein the first and the second emission layers respectively comprise an anode, and the anode is a transparent layer.

14. The system as claimed in claim 2, wherein the storage capacitor, the first transistor, the second transistor, the first switch unit and the second switch unit are disposed at a back region of the first display unit.

15. The system as claimed in claim 1, wherein a color filter is disposed on a light penetration path of the second display unit.

16. The system as claimed in claim 1, wherein the first display unit emits light when the control signal is at high voltage level, and the second display unit emits light when the control signal is at low voltage level.

17. The system as claimed in claim 1, wherein the first display unit emits light when the control signal is at low voltage level, and the second display unit emits light when the control signal is at high voltage level.

18. The system as claimed in claim 1, wherein the first emission period and the second emission period are within a period of one frame.

19. The system as claimed in claim 1, further comprising a display panel, wherein the pixel unit forms a portion of the display panel.

20. The system as claimed in claim 1, further comprising an electronic device, wherein the electronic device comprises:
the display panel; and
the power supply coupled to and supplying power to the display panel.

21. The system as claimed in claim 20, wherein the electronic device is a mobile phone, a digital camera, a PDA, a notebook computer, a desktop, a television, a GPS, an automotive display, an avionics display or a portable DVD player.
